(19) United States
(12) Patent Application Publication
(10) Pub. No.: US 2024/0362593 A1
(43) Pub. Date: Oct. 31, 2024

(54) SCREEN EQUIPPED ITEM IDENTIFICATION USING INDICIA

(71) Applicant: UNEFI INC., Toronto (CA)

(72) Inventors: Ranko DIMIC, Toronto (CA); Samuel Arthur VISE, Toronto (CA); Tibor SZANTO, Toronto (CA)

(21) Appl. No.: 18/687,250

(22) PCT Filed: Aug. 17, 2022
(86) PCT No.: PCT/CA2022/051250

§ 371 Date: Feb. 27, 2024

Related U.S. Application Data
(60) Provisional application No. 63/239,099, filed on Aug. 31, 2021.

(51) Int. Cl. G06Q 10/109; G06F 3/0482; G06K 7/14

(52) U.S. Cl. CPC G06Q 10/109; G06F 3/0482; G06K 7/1417

(57) ABSTRACT

Systems and methods relating to item identification. A machine readable indicia (such as a bar code or a QR code or other machine readable indicia) is displayed on a screen of an item to be identified. The indicia, when read and decoded by another device, provides details regarding the item's identity. To set the identity, a user is provided with a listing of possible identities for the item and the user selects one of the possible identities. A suitable machine readable indicia, based on the user's selection, is then downloaded or stored on the item for display on the item's screen. The indicia and/or the listing may be stored on a database remote from the item.

### TECHNICAL FIELD

The present invention relates to inventory management and to managing product displays. More specifically, the present invention relates to systems and methods for item identification.

### BACKGROUND

Product display management and keeping track of what products are on display and where these are supposed to be placed can be a time consuming and difficult task, especially for large organizations with many stores. Such large organizations require that their displays be uniform across multiple locations and ensuring that uniformity is challenging, to say the least.

Many such organizations have taken to using automated systems to ensure that such displays are properly implemented in each store. There are now systems that enables store managers to check each display against a head office mandated configuration to thereby ensure that each display conforms to that configuration. This can, of course, be done manually but, as can be imagined, this can take quite a bit of time and effort on the part of those who have to manage each store's displays.

Current systems for managing displays, even the most advanced ones, still require display managers to determine which product is displayed where on a shelf. As well, especially for items that have little visual variations across brands, determining which item is on display can be a time consuming and annoying task for such managers. For example, most smartphones look very much alike across different brands and models-they are a simply black slabs with a glass display screen and, other than a close inspection of the outside and/or a detailed look at the device when operating, it can be difficult to determine which item is which. The same could be said for notebooks, tablets, and other electronic devices.

There is therefore a need for systems and methods that allow for easy identification of devices on display on a shelf. Preferably, such systems and methods are easily integrated with inventory management and product display management systems.

### SUMMARY

The present invention provides systems and methods relating to item identification. A machine readable indicia (such as a bar code or a QR code or other machine readable indicia) is displayed on a screen of an item to be identified. The indicia, when read and decoded by another device, provides details regarding the item's identity. To set the identity, a user is provided with a listing of possible identities for the item and the user selects one of the possible identities. A suitable machine readable indicia, based on the user's selection, is then downloaded or stored on the item for display on the item's screen. The indicia and/or the listing may be stored on a database remote from the item.

In one aspect, the present invention provides a system for identifying an item, the system comprising:
a user interface on a screen of said item;
a machine readable indicia displayed on said user interface;
wherein
said machine readable indicia is for reading by a device different from said item;
when said machine readable indicia is analyzed, said machine readable indicia provides an identification of said item.

In one embodiment, the present invention further comprises a database containing a listing of multiple items. The machine readable indicia may be based on a single item selected from the listing. The machine readable indicia may be retrieved from the database. The database may be remote from a location of the item.

In another embodiment, the listing is presented to a user and the user selects said single item from the listing. The machine readable indicia may be generated by the item. As well, the database may be stored on the item.

In some embodiments, the user is required to login to access the database. The contents of the listing may be based on an identification of a facility where the item is located. This listing may be based on which items are available at the facility.

In another aspect, the present invention provides a method of identifying an item, the method comprising:
a) providing a listing of multiple items on a user interface of said item;
b) receiving input indicating a single selected item selected from said listing;
c) determining a relevant machine readable indicia that is associated with said single selected item;
d) displaying said relevant machine readable indicia on said user interface of said item;

wherein
said relevant machine readable indicia is for reading by a device different from said item;
when said relevant machine readable indicia is analyzed, said relevant machine readable indicia provides an identification of said item.

For some implementations of the method, included is a step of retrieving the relevant machine readable indicia from a database prior to step d). Alternatively, the method may include a step of generating the relevant machine readable indicia prior to step d). The listing may be retrieved from a database. And database may be stored remotely from the item. Alternatively, the database may be stored on the item.

In some embodiments, the contents of the listing may be dependent on a location of said item. The contents of the listing may be dependent on which items are available for a location where the item is located.

A further aspect of the present invention provides a method for determining an identity of an item to be moved and a location where said item is to be moved, the method comprising:
prompting a user to scan a machine readable indicia displayed on said item said machine readable indicia being for identifying said item;
prompting said user to take a digital image of said item at said location after said item has been moved;
receiving and decoding scanned said indicia in response to said prompting to thereby identify said item;
performing image recognition on said digital image;
determining surrounding items adjacent said item at said location from said digital image;
comparing said surrounding items from said digital image with expected surrounding items from a database;
in the event there is a match between said surrounding items from said digital image and said expected surrounding items, confirming that said item is placed at a correct location.

In a further aspect, the present invention provides a method for confirming that an item and a location where said item is located on a fixture in a retail establishment is correct, the method comprising:
prompting a user to scan a first machine readable indicia displayed on said item, said machine readable indicia being for identifying said item;
prompting said user to scan a second machine readable indicia displayed to thereby associate said second machine readable indicia with said location;
receiving and decoding scanned indicia in response to said prompts to thereby identify said item and said location whose associated indicia has been scanned;
accessing a database to retrieve a correct item-location pair of identities for said item and said location;
comparing identities of said item and said location scanned with said pair of identities accessed from said database;
in the event there is a match between said identities and said pair of identities, confirming that said item is placed at a correct location.

### BRIEF DESCRIPTION OF THE DRAWINGS

The embodiments of the present invention will now be described by reference to the following figures, in which identical reference numerals in different figures indicate identical elements and in which:

FIG. 1 is a block diagram that schematically illustrates the components of one aspect of the present invention;

FIG. 2 is screenshot of a login page detailing one implementation of the present invention;

FIG. 3 illustrates a screenshot of a sample listing of possible identities for an item; and

FIG. 4 is a screenshot of a QR code as used in one implementation of the present invention.

### DETAILED DESCRIPTION

In one aspect of the present invention, computer readable readable indicia is presented on an item's screen, the item being a sample item for display at a retail establishment. The indicia, once read and analyzed by a suitable device, identifies the item, including, at the very least, the item's make and model. The identification of the item may include the item's color as well as any other accessories that may be installed on the item. The display of the indicia on the item's screen allows the indicia to be scanned by a suitable device to thereby identify the item. The identification of the item can be paired with the position of the item on a display shelf/display location in the retail establishment and this identification/location pair can be used to determine if the retail establishment is conforming to display requirements. As noted above, these display requirements or display configurations may be set by a head office in a larger retail organization. The ability to quickly and automatically identify an item on a display allows for much quicker determination of display inventory as well as conformity (or non-conformity) to any required display configurations.

To implement the present invention, a user first installs a suitably configured app or application on an item. The app is launched and, after suitable preliminary steps (e.g., having the user log in), the user is provided with a listing of devices. The user can then select, from the listing, the identity of the device being used. Once the identity is set, a suitable machine readable indicia (or computer readable indicia) such as a bar code or a QR code is set for display on the item's screen. Whenever the app is called up and executed, that indicia is displayed on the screen. As noted above, the indicia, when analyzed, provides the data that identifies the item. The identity of the item can be as detailed or as broad as necessary or as desired. It should be clear that, for some implementations, a direct decryption or direct processing of the machine readable indicia results in a direct listing of an item's make, model, and other identifying data. However, for some implementations, a decryption or processing of the indicia may provide an index to a database or listing, with the database or listing providing the actual identification data for that item.

It should be clear that the indicia to be displayed on the item's screen may be stored in a database stored on the item itself or on a database remote from the item. Once the user has selected the suitable identity for the item, the relevant indicia is retrieved from the database and stored on the item, thereby allowing for a display of the indicia on the item screen when necessary. If the database is stored on the item, this database can be downloaded when the application software is downloaded or installed on the item. Similarly, the database, if remote from the item, may be accessed remotely by the item as necessary. Of course, access to the database may require the user to login to one or both of the software itself and the database. Depending on the implementation, the logging in step may be performed once when the user initially launches the software application or it may be performed whenever the software application is accessed.

Regarding the list of possible identities for the item, as noted above, the user selects an identity for the item. The contents of the list may be preset and fixed or the list may be dynamic. Dynamic list contents may be retrieved from a database remote from the item once the user has logged in to the database or the system that operates/hosts the database. It should be clear that the list contents may be dependent on the physical location of the item. As an example, the present invention may be used with an inventory management system for a large retailer with multiple locations. Thus, an item located at a store at location A may need to download a list having different contents than a list for an item at a store at location B. This may be because the items for display at location A may be different from the items at location B. Thus, when a user logs in to the system that operates/hosts the database, the user may need to provide a location of the retail establishment where the item is location or the system may, by knowing the user's identity, already known the item's location (i.e., the user account used to log in is only associated with the specific location where the item is located). Once the user's location (and hence the item's location) is known, the proper listing can be downloaded. After the listing has been downloaded, the user is then provided with the contents of the listing and can select the identity for the item. The download of the listing may be accompanied with a downloading of the indicia associated with each one of the listing contents or the single relevant indicia may be downloaded once the user has selected a specific identity for the item.

It should also be clear that, depending on the implementation, there may not be a listing provided to the user. The user, after logging in, would simply be provided with questions and, as the user answers these questions, the field of possible identities for the item narrows. Once the field has narrowed to only a few possible options for an identity, the user can be provided with these identities and can choose one of these identities for the item. As an example, the user may be provided with a menu detailing possible options for the item identity such as: TVs, notebooks, tablets, and mobile handsets. Once the user has selected mobile handsets, the menu then asks for the make/manufacturer of the mobile handset by listing the possibilities for that specific store (i.e., which manufacturer of mobile handsets have products on display at that store location). Thus, the user would, for example, be provided with the options of: Samsung™, Sony™, Apple™, Huawei™, OnePlus™, and Nokia™. After the user selects one of these manufacturers, depending on the number of products on display for that store for the selected manufacturer, the user can be provided with the various models for that manufacturer. The user can then select the final identity for the item. After this final selection, the relevant indicia for that identity is downloaded on to the item and is set to be displayed on the item screen when the software application is subsequently launched.

After the item's identity has been selected and the relevant indicia has been downloaded (or created), the app automatically sets itself to display the indicia on the screen the next time to app is launched. Prior to doing inventory or doing a sweep on the displayed items to ensure conformity with display requirements as set by a head office, the user launches the app on this and other items. The user can then use a mobile device (or a suitable portable computing device such as a tablet) to take photos or videos of the configuration of each display shelf or unit. The indicia displayed on each item's screen (where possible) will be visible/viewable on the pictures/video and each indicia can be separately analyzed to determine each item's identity. The placement of each item on the display shelf can also be determined and, with the identity and the shelf placement, the overall shelf/display configuration (as seen by the user) can be determined. The shelf/display configuration can then be compared with the display requirements as set out by head office and a determination can be made as to whether the retail establishment is conforming to the display requirements.

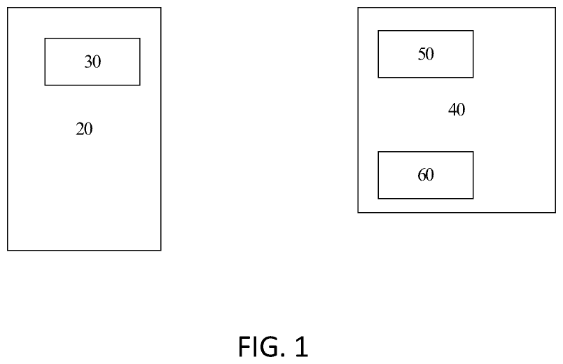

One aspect of the present invention can be schematically seen in the block diagram of FIG. 1. As can be seen, the system 10 includes the item 20 to be identified with a software application 30 running on the item 20. To set up the system, after user login, the item accesses a database 40 to retrieve a listing 50 of the possible identities of the item 20. The listing 50 is then presented to the user and the user selects an identity for the item 20. Once the identity has been selected, a suitable indicia 60 detailing that identity is retrieved from the database 40) and stored on the item. The application 30 then configures itself to display the indicia on the item screen whenever the application 30 is launched.

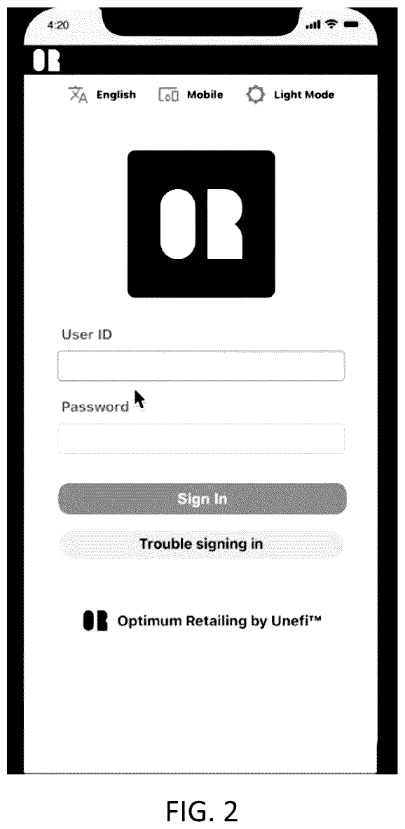

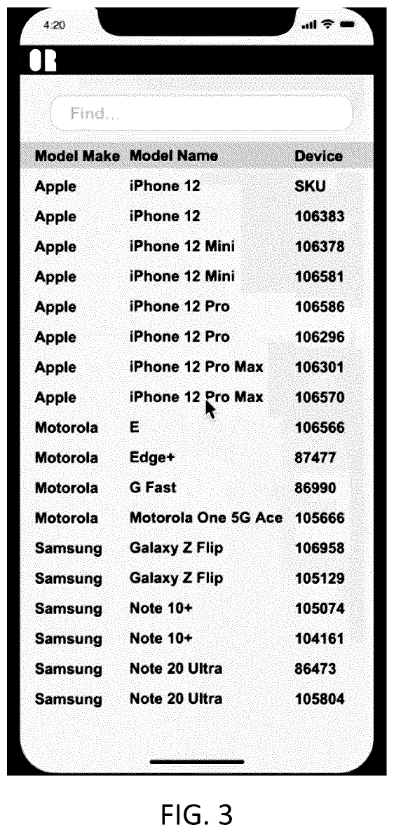

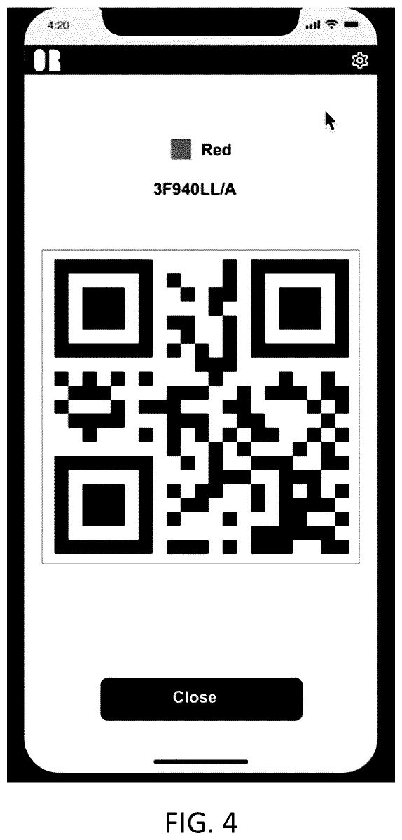

Referring to FIGS. 2-4, illustrated are screenshots of one implementation of one aspect of the present invention. In FIG. 2, a screenshot of a login screen for the software application is illustrated. After a user has logged in, the application accesses a database to retrieve the listing. In some implementations, the user may need to provide a URL for the database or for the gateway to the database. In other implementations, the application may be hard-coded to only access a specific database at a specific URL. After login, a suitable listing of possible identities is presented to the user (see FIG. 3). As noted above, this listing may be dependent on the item's location, what items are available for that location, as well as what items are known to be available across the various locations. The user then selects the suitable identity for the item. A suitable indicia (e.g., a QR code, bar code or some other computer readable indicia) is then retrieved from the database or is generated and then stored on the item. The indicia is then displayed on the item's screen (see FIG. 4) so that other systems can be used to quickly identify and locate (on the display shelf) the various items on display.

As another aspect of the present invention, the system may also be used to ensure that the item is placed in the correct spot on a display fixture in the retail establishment. For this aspect of the present invention, each spot or location on the display fixture is associated with a specific machine readable indicia (e.g., a bar code or a QR code) that can be scanned by a user's portable data processing device (e.g., a tablet or smartphone). The machine readable indicia is located at each spot and can be scanned by the user's device. Once the correct spot or location has been scanned, the user can then be instructed to place the specific item (previously identified) on that spot or location. For confirmation, after the user has placed the item on the spot, the user is prompted to scan the item's indicia again to confirm the identity of the item on the particular spot.

Alternatively, once an item has been placed on a specific spot/location with a visible machine readable indicia, the item's indicia (previously set as explained above) can be displayed. The user can then scan both machine readable indicia (one for the item and one for the spot/location) to confirm that the correct item is now placed at the correct location on the fixture.

As can be imagined, having a user scannable machine readable indicia associated (and displayed) for each fixture and a set identity for each item allows for an item-location pair to be determined. For every item-location pair that does not conform to a desired configuration, the user can be notified to correct the error. The user can then move the identified item to the correct location.

It should be clear that, as noted above, each location on a fixture is to be associated with (and preferably will have) a machine readable indicia (such as a QR code or bar code). This machine readable indicia will, once decoded, indicate the specific location on that fixture. Preferably, the indicia will be displayed adjacent to or near the actual location to thereby associate the indicia with the specific location. The fixture's identity and location within the retail establishment can be determined/set using other methods (e.g., by pre-arrangement or by having other means to identify specific fixtures and fixture locations in the retail establishment). With the specific location on that fixture for that specific identified item, the desired configuration for that item can be set. By ensuring that the specific identified item is at the desired identified location, then that part of the configuration can be confirmed to be correct.

In the event an item is to be moved from location A to location B on the same fixture, the user can be prompted to, by way of the user's device, activate the app on the item to display the item's machine readable indicia associated with its identity. The user is then prompted, again through the user's device, to scan that indicia on the item and to scan the machine readable indicia of the current location of the item. This allows the app on the user device to determine the item and its current location on the fixture. Once the correct identity of the item has been determined and the correct current location has been determined, the user can be prompted to scan the projected new location for the item. This involves having the user scan the machine readable indicia for the new projected location (the new projected location being indicated on the user's device).

Once the correct new projected location has been scanned by the user and the indicia of the correct new projected location indicates the correctness of the location, the user is prompted to move the item to that new location. After the move, the user is prompted to scan both the item's indicia and the new location's indicia (depending on the placement of the location's indicia, this may be done with a single scan). The app can then confirm that the specific item is now placed at the specific location.

It should be clear that, after the app on the user's device prompts the user to scan the indicia for a specific spot/location on the fixture, the app may be configured to continue prompting the user to scan the correct indicia until the correct indicia has been scanned. This ensures that the user is following the instructions on the app and that the app will not progress until the user has scanned the correct indicia for the correct location. Once the correct location has been scanned, the user can then be prompted to scan the indicia for the correct item and, again, the app will not progress until the user has scanned the correct item. This will ensure that the user has located the correct item to be placed/moved/identified. Confirmation that the move/placement of the correct item to the correct location can then be executed by prompting the user to scan both the indicia for the placed item as well as the indicia for the location where the item was placed. Assuming both the item and the location are correct and that the scanning has been successful, the app can progress and/or indicate success. Alternatively, if either or both of the indicia scanned is incorrect, the user can be continuously prompted to scan the correct item and/or location indicia.

It should also be clear that the correctness of the item and/or the location is determined by having the app on the user device confirm the item's identity and/or the location's identity/locale from a database. The database is resident either on the user device or at a remote server. The database would contain the correct item-location pair and, if the indicia scanned by the app indicate the correct item-location pair, then the item is determined to be at the correct location. This confirmation/determination can be executed whether one is confirming the correctness of an item's location or whether the location where the item is to be moved to and the item's identity is being determined.

It should also be clear that the above explanation uses the concept of multiple machine readable indicia to ensure that the correct item is placed at the correct location. As an alternative to this, the user's device can take an image or a photograph of the correct item placed at a new location. This image or photograph can then be analyzed (using image recognition) to ensure that the correct location has been selected. This can be done by analyzing what surrounds the item at the new location. By ensuring that the expected surrounding circumstances are correct (e.g., the items around the identified item are what is expected), the correctness of the new location can be determined. Of course, the image recognition process can be executed on the user's device or the image can be uploaded to a server for analysis.

For clarity, once the identified item (i.e., an item identified by its machine readable indicia displayed on its screen) has been placed on a new location, the user can be prompted to take a digital image of the item and its surroundings. This may mean taking an image that includes items adjacent to the identified item. The image can then be analyzed to identify (through image recognition) what items are adjacent the identified item. As an example, if the expected items adjacent the identified item are correctly identified (or identified to within acceptable parameters), then the location is considered/determined to be correct. Thus, if, to the left of the identified item there is expected to be a package of specific earbuds displayed and to the right there is expected to be a specific brand of smartphone on display, then image recognition can determine if these items are present. As well, specific advertising displays may be expected to be adjacent/near the identified item. If image recognition identifies/finds these specific items in the image taken by the user, then the location for the identified item is considered to be correct.

It should also be clear that the determination of what items/advertising is expected to be adjacent/near the identified item may involve at least one reference to a database. The database would store indications as to what items are expected to be adjacent the identified item at the correct location. Once these items are found (by way of image recognition) in the digital image taken by the user of the identified item at the new location, then the new location can be considered/determined to be correct.

It should be clear that the various aspects of the present invention can be implemented on any device that is equipped with a screen and has the capability to execute apps or application software. Network connectiveness is not necessary as the database and the indicia may be stored on the item but would be preferable to ensure that the database and the indicia can be changed when required. As such, the present invention may be used to identify items such as smart televisions, mobile handsets, smartphones, tablet computers, smart watches, and even screen equipped smart appliances.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, embodiments may be implemented in a procedural programming language (e.g., “C”) or an object-oriented language (e.g., “C++”, “java”, “PHP”, “PYTHON” or “C#”) or in any other suitable programming language (e.g., “Go”, “Dart”, “Ada”, “Bash”, etc.). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1. A system for identifying an item, the system comprising:
a user interface on a screen of said item;
a machine readable indicia displayed on said user interface;
wherein
said machine readable indicia is for reading by a device different from said item;
when said machine readable indicia is analyzed, said machine readable indicia provides an identification of said item.

2. The system according to claim 1, further comprising a database containing a listing of multiple items and wherein said machine readable indicia is based on a single item selected from said listing.

3. The system according to claim 2, wherein said machine readable indicia is retrieved from said database.

4. The system according to claim 2, wherein said listing is presented to a user and said user selects said single item from said listing.

5. The system according to claim 1, wherein said machine readable indicia is generated by said item.

6. The system according to claim 2, wherein said database is remote from a location of said item.

7. The system according to claim 2, wherein said database is stored on said item.

8. The system according to claim 4, wherein said user is required to login to access said database.

9. The system according to claim 2, wherein contents of said listing is based on an identification of a facility where said item is located.

10. The system according to claim 9, wherein said listing is based on which items are available at said facility.

11. A method of identifying an item, the method comprising:
a) providing a listing of multiple items on a user interface of said item;
b) receiving input indicating a single selected item selected from said listing;
c) determining a relevant machine readable indicia that is associated with said single selected item;
d) displaying said relevant machine readable indicia on said user interface of said item;
wherein
said relevant machine readable indicia is for reading by a device different from said item;
when said relevant machine readable indicia is analyzed, said relevant machine readable indicia provides an identification of said item.

12. The method according to claim 11, further including a step of retrieving said relevant machine readable indicia from a database prior to step d).

13. The method according to claim 11, further including a step of generating said relevant machine readable indicia prior to step d).

14. The method according to claim 11, wherein said listing is retrieved from a database.

15. The method according to claim 14, wherein said database is stored remotely from said item.

16. The method according to claim 14, wherein said database is stored on said item.

17. The method according to claim 11, wherein contents of said listing are dependent on a location of said item.

18. The method according to claim 17, wherein contents of said listing are dependent on which items are available for a location where said item is located.

19-24. (canceled)
